(19) United States
(12) Patent Application Publication
(10) Pub. No.: US 2006/0148635 A1
(43) Pub. Date: Jul. 6, 2006

(54) Optical glass, optical element using the optical glass and optical instrument including the optical element

(76) Inventors: Taro Miyauchi, Tokyo (JP); Kei Yamada, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/543,776

(22) PCT Filed: Mar. 25, 2004
(86) PCT No.: PCT/JP04/04180

§ 371 Date: Jul. 29, 2005

(30) Foreign Application Priority Data
Mar. 26, 2003 (JP) 2003-85226

(51) Int. Cl. C03C 3/089; C03C 3/095

(52) U.S. Cl. 501/65; 501/64

(57) ABSTRACT

A mother glass of the present invention for an optical element contains thallium and a boron oxide, serving as an essential component. Therefore, it is possible to manufacture a homogeneous glass body having a low melting temperature and excellent moldability. Further, it is possible to manufacture a distributed index lens having a refractive index distribution required for an optical design, a wide effective visual field, and excellent weather resistance by contacting the glass body with the melted salt of an alkali metal to perform ion exchange. Furthermore, it is possible to provide an optical element and an optical device having excellent optical characteristics by using the distributed index lens.

### TECHNICAL FIELD

The present invention relates to a glass composition suitable for manufacturing a light transmitting body, particularly, a lens having a distributed refractive index gradient in which a refractive index is continuously changed from a central axis toward a surface thereof, preferably in a parabolic shape (hereinafter, referred to as a distributed index lens) and to the distributed index lens having the lens composition. More specifically, the present invention relates to an optical element in which the distributed index lenses having the glass composition are zero-, one- or two-dimensionally arranged and to an optical device using the same.

### BACKGROUND ART

In general, the distributed index lens has a cylindrical shape. The distributed index lens preferably has a refractive index represented by the following Expression 1 in a cross-section perpendicular to a central axis of the cylindrical lens:
N(r)=N₀(1−Ar²) [Expression 1]

where a refractive index at the center is N₀, a distance from the center in the radius direction is r, and a positive number is A.

As a method of manufacturing the distributed index lens, there has been known a method in which a glass rod (or fiber) consisting of a predetermined composition containing a thallium oxide contacts a source of alkali metal ions, for example, the melted salt of potassium, to perform the ion exchange between the glass rod and the melted salt, so that the density distribution of a material in the radius direction is continuously changed.

Further, there has been known a method in which the glass rod obtained in this way is formed in a cylindrical shape, so that a distributed index lens having a refractive index distribution close to Expression 1 in a cross section perpendicular to the central axis of the cylinder is manufactured (for example, see Japanese Examined Patent Application Publication Nos. 61-46416 and 62-43936).

However, in the glass rod consisting of the composition manufactured by the conventional technique, it is necessary to melt glass materials at a high temperature, and it is difficult to obtain a homogeneous glass rod.

In general, in a heterogeneous glass body, uniform ion diffusion is not performed at the time of an ion exchanging process, which results in an obstruction to continuity.

Therefore, it is difficult to obtain a lens having a good refractive index as represented by Expression 1 using the conventional manufacturing method. That is, the distributed index lens manufactured by the conventional manufacturing has a refractive index distribution greatly deviated from that represented by Expression 1. Therefore, it is difficult for the lens to have an effective visual field in the periphery of the cylindrical shape.

Further, when an optical element is formed by one- or two-dimensionally arranging a plurality of the distributed index lenses manufactured by the conventional manufacturing method, the optical characteristics of the optical element deteriorate due to the poor refractive index distribution of each lens.

That is, since the periphery of each of the cylindrical lenses in the optical element deviates from the effective visual field, images obtained from the peripheries of the respective lens overlap each other as noise, which results in the deterioration of optical characteristics of the entire lens array, for example, the deterioration of resolution.

Furthermore, in general, since the volatile amount of the thallium oxide exponentially increases with a rise in temperature, it is preferable to lower the melting temperature of a glass material in order to obtain high homogeneous glass.

However, when the melting temperature falls down, the viscosity of glass increases, and thus the moldability of glass deteriorates. Therefore, it is demanded to develop the composition of a glass material having lower viscosity at a lower temperature.

### DISCLOSURE OF INVENTION

The present invention is designed to solve the above-mentioned problems, and it is an object of the present invention to provide a glass composition suitable for manufacturing a distributed index lens having excellent optical characteristics and weather resistance.

Another object of the present invention is to provide the distributed index lens having excellent optical characteristics and weather resistance, an optical element that is constructed by the lens and has excellent optical characteristics, and an optical device using the optical element.

(1) In order to achieve the above-mentioned objects, the present invention provides a glass body, consisting of: 35 to 80 mol % of SiO₂, 0.1 to 40 mol % of B₂O₃, 1 to 26 mol % of Tl₂O, 1 to 34 mol % of K₂O, 0 to 30 mol % of ZnO, 0 to 30 mol % of GeO₂, 0 to 20 mol % of TiO₂, 0 to 20 mol % of MgO, 0 to 2 mol % of ZrO₂, 0 to 8 mol % of Al₂O₃, 0 to 5 mol % of SnO, 0 to 5 mol % of La₂O₃, 0 to 8 mol % of Bi₂O₃, 0 to 2 mol % of Ta₂O₅, 0 to 1 mol % of Sb₂O₃, and 0 to 1 mol % of As₂O₃, wherein the glass body contains 2 to 26 mol % of Na₂O+Li₂O; 0.2 to 5.5 mol % of (Na₂O+Li₂O)/Tl₂O; 5 to 35 mol % of Tl₂O+R₂O (where R is an alkali metal); 0 to 10 mol % of BaO+CaO+SrO; 0 to 8 mol % of ZrO₂+Al₂O₃+SnO(SnO₂); and 50 to 80 mol % of SiO₂+GeO₂+TiO₂+B₂O₃+ZrO₂+Al₂O₃.

According to the present invention, the glass body contains 35 to 80 mol %, preferably 40 to 70 mol % of SiO₂. The SiO₂ has been well known as a glass matrix forming material. When SiO₂ has a composition range less than 35 mol %, which is the minimum value, the endurance or stability of glass deteriorates. On the other side, when SiO₂ has a composition range larger than 80 mol %, which is the minimum value, the melting temperature of glass rises, and the necessary amount of other components is not secured. Therefore, it is difficult to attain the objects of the present invention.

Further, the glass body contains 0.1 to 40 mol %, preferably 0.5 to 25 mol % of B₂O₃. The B₂O₃ is also a glass matrix forming material and is an essential material for decreasing the melting temperature of glass. Further, when ion exchange is performed with the glass body to form a distributed index lens, the B₂O₃ is a material necessary for improving the optical performance of the lens.

That is, in the glass body containing B₂O₃ in the above-mentioned composition range, it is possible to obtain a high-quality lens having a refractive index distribution extremely close to the preferred refractive index distribution represented by Expression 1 through an ion exchanging process.

In order to improve the optical performance of the lens, it is preferable that the glass body contain B₂O₃ larger than 0.5 mol %. In addition, since a raw material of B₂O₃ is more expensive than that of SiO₂, it is preferable that B₂O₃ be less than 25 mol % for industrial use, which does not influence the optical characteristics of the lens.

Further, the glass body contains 1 to 30 mol %, preferably 2 to 10 mol % of Tl₂O. Tl₂O is an essential component used for ion-exchanging the glass body to obtain a distributed index lens. In the ion exchange, the component is used for contacting the glass body with the melted salt of an alkali metal to perform the ion exchange between Tl ions contained in the glass body and alkali metal ions contained in the melted salt. When a density distribution of the Tl ions and the alkali metal ions occurs in the glass body by the ion exchange, the glass body has a refractive index gradient according to an ion density distribution continuously changed in a predetermined direction and exhibits the optical performance, that is, functions as a lens.

Furthermore, when a Tl₂O content of the glass body is less than 1 mol %, which is a minimum value, it is difficult to obtain a lens having desired optical characteristics, for example, a desired lens aperture angle. On the other hand, when the Tl₂O content of the glass body is larger than 30 mol %, which is a maximum value, the weather resistance of the glass body deteriorates.

Moreover, the glass body contains 1 to 34 mol %, preferably 2 to 34 mol % of K₂O. K₂O is the source of potassium ions in the glass and is an essential component used for ion-exchanging the glass body to obtain a distributed index lens. Potassium ions generated in the glass body are diffused in the glass, similar to alkali metal ions whose source is the melted salt of an alkali metal in contact with the outside of the glass body, and are mainly ion-exchanged with Tl ions, which results in a decrease in a refractive index of the glass body.

Further, when a K₂O content of the glass body is less than 1 mol %, which is a minimum value, a refractive index distribution of the glass body by the ion exchange greatly deviates from that represented by Expression 1, and thus it is difficult to obtain desired lens characteristics. On the other side, when the K₂O content of the glass body is larger than 34 mol %, which is a maximum value, the weather resistance of the glass body deteriorates.

Furthermore, a total content of Tl₂O and R₂O (where R is an alkali metal) of the glass body is in a range of 5 to 40 mol %, preferably 10 to 30 mol %. When the total content of the oxide of the alkali metal containing the thallium oxide is less than the minimum value, it is difficult to obtain a desired lens aperture angle from a distributed index lens obtained by ion-exchanging the glass body. In addition, in this case, the melting temperature of glass increases, and thus Tl₂O is rapidly volatilized, which results in the lowering of homogeneity of a glass body to be formed. On the other side, when the total content of the oxide of the alkali metal containing the thallium oxide is larger than the maximum value, the weather resistance of a glass body to be formed deteriorates.

The alkali metal oxide represented by R₂O contains at least one of Na₂O and Li₂O oxides as an essential component. A total content (Na₂O+Li₂O) of the Na₂O and Li₂O oxides is in a range of 2 to 26 mol %, preferably 5 to 18 mol %.

Further, a ratio of the (Na₂O+Li₂O) content to the Tl₂O content ((Na₂O+Li₂O)/Tl₂O) is in a range of 0.2 to 5.5, preferably 0.5 to 3.0.

Na₂O and Li₂O supply Na ions and Li ions having relatively small radiuses among various alkali metal ions in charge of the ion exchange between the glass body and the melted salt. These alkali metal ions having small radiuses are characterized in that they are diffused in the glass at high speed during the ion exchanging process. Therefore, even when ion exchange is performed between thallium ions and potassium ions having relatively large radiuses, it is possible to easily adjust optical characteristics of a distributed index lens obtained by ion-exchanging the glass body, such as an aperture angle and a refractive index distribution in a wider range.

Thus, when the (Na₂O+Li₂O) content is less than the minimum value, the melting temperature of glass increase. On the other hand, when the ratio of the (Na₂O+Li₂O) content to the Tl₂O content is less than the minimum value, it is hard to obtain the above-mentioned effects. Meanwhile, when the (Na₂O+Li₂O) content is larger than the maximum value, the weather resistance of the glass body deteriorates. In this case, a crack may occur in the glass body during the ion exchanging process, or the glass body may be devitrified. Further, when the ratio of the (Na₂O+Li₂O) content to the Tl₂O content is larger than the maximum value, it is difficult to obtain a lens having desired optical characteristics, for example, desired lens aberration.

Furthermore, the contents of Na₂O and Li₂O are selected in consideration of both the content of (Na₂O+Li₂O) and the ratio of the content of (Na₂O+Li₂O) to the Tl₂O content. In addition, a ratio of the Na₂O content to the Li₂O content is selected in consideration of both the advantage of Li₂O over Na₂O and the disadvantage of Li₂O over Na₂O.

That is, the advantage of Li₂O over Na₂O is that it is possible to decrease the melting temperature of glass by adding a small amount of Li₂O. On the other hand, there is a disadvantage in that glass containing Li₂O can be more easily devitrified than glass containing Na₂O. Therefore, the ratio of the Na₂O content to the Li₂O content is preferably selected in consideration of these points.

It is possible to appropriately use K₂O and Cs₂O as alkali metal oxides R₂O other than the above-mentioned alkali metal oxide from the viewpoint of raw material costs. However, it is also possible to use other alkali metal oxides according to the degree of necessity.

Further, the glass body can contain the following additional components.

A ZnO content of the glass body is in a range of 0 to 30 mol %, preferably 3 to 25 mol %. The ZnO functions to extend a vitrification range and to decrease the melting temperature of the glass body. When the ZnO content is larger than the maximum value, the weather resistance of the glass body deteriorates.

Further, a GeO₂ content of the glass body is in a range of 0 to 30 mol %, preferably 3 to 15 mol %. GeO₂ is a glass matrix forming oxide and has effects of extending a vitrification range and of decreasing the melting temperature of glass. These effects are less than those obtained by B₂O₃. Therefore, the GeO₂ content is selected from the composition range in consideration of the B₂O₃ content.

Furthermore, the glass body may contain at least one of BaO, CaO, and SrO. A total content of these components is in a range of 0 to 10 mol %. These oxides are used to extend a vitrification range and to improve solubility. However, when the total content of these oxides is larger than 10 mol %, which is a maximum value, ion exchange is not smoothly performed, so that the refractive index distribution of a lens obtained by ion-exchanging the glass body deviates from the refractive index distribution represented by Expression 1. As a result, it is difficult to obtain a high-quality lens.

Moreover, a TiO₂ content of the glass body is in a range of 0 to 30 mol %, preferably 1 to 15 mol %. TiO₂ is a glass matrix forming component and functions to improve a refractive index. TiO₂ has effects of extending a vitrification range and of decreasing the melting temperature of glass. However, when the TiO₂ content is larger than 30 mol %, which is a maximum value, glass is devitrified, and remarkable coloring occurs in the glass.

Further, an MgO content of the glass body is less than 20 mol %, preferably less than 15 mol %. MgO has an effect of extending a vitrification range. However, when the MgO content is larger than the maximum value, the melting temperature of glass increases.

Furthermore, the glass body may contain at least one of ZrO₂, Al₂O₃, and SnO(SnO₂). A total content of these oxides is in a range of 0 to 8 mol %.

These oxides improve the weather resistance of the glass body at the time of an ion exchanging process and also improve the weather resistance of a lens obtained by the ion exchange. However, when the total content of these oxides is larger than 8 mol %, which is a maximum value, the solubility of glass deteriorates, and remarkable coloring occurs in the glass. Therefore, the total content is preferably in a range of 0.1 to 3 mol % in the productivity respect.

Further, the content of each oxide has the following maximum value.

ZrO₂ functions to increase a refractive index of glass and to improve weather resistance thereof. When a ZrO₂ content is larger than 5 mol %, which is a maximum value, the solubility of glass deteriorates. Therefore, the ZrO₂ content is preferably less than 2 mol % in the productivity respect.

An Al₂O₃ content is less than 8 mol %, preferably less than 2 mol %. When the Al₂O₃ content is larger than the maximum value, the solubility of glass deteriorates, which is not desirable to improve productivity.

A SnO(SnO₂) content is less than 5 mol %, preferably less than 2 mol %. When the SnO(SnO₂) content is larger than the maximum value, it is easy for a crystal to be deposited, and thus glass is colored and crystallized, resulting in the deterioration of solubility.

Further, a total content of glass matrix forming components having a strong covalent bonding characteristic, such as SiO₂, GeO₂, TiO₂, B₂O₃, ZrO₂, and Al₂O₃, in the glass body is in a range of 50 to 80 mol %. When the total content of these oxides is less than 50 mol %, which is a minimum value, the weather resistance of glass deteriorates. On the other hand, when the total content is larger than 80 mol %, which is a maximum value, the melting temperature of glass increases, and a necessary amount for other components is not secured. Therefore, it is difficult to achieve the objects of the present invention.

Furthermore, a La₂O₃ content of the glass body is in a range of 0 to 5 mol %, preferably 0 to 3 mol %. La₂O₃ also has an effect of increasing a refractive index of glass. However, when the La₂O₃ content is larger than the maximum value, ion exchange is not smoothly performed in the glass body. Therefore, the refractive index distribution of a lens obtained by ion exchange deviates from the refractive index distribution represented by Expression 1, and thus it is difficult to obtain a high-quality lens.

Moreover, a Ta₂O₅ content of the glass body is in a range of 0 to 5 mol %, preferably 0 to 2 mol %. Ta₂O₅ also has an effect of increasing a refractive index of glass. However, when the Ta₂O₅ content is larger than the maximum value, ion exchange is not smoothly performed in the glass body. Therefore, the refractive index distribution of a lens obtained by ion exchange deviates from the refractive index distribution represented by Expression 1, and thus it is difficult to obtain a high-quality lens.

Further, a Bi₂O₃ content of the glass body is in a range of 0 to 10 mol %, preferably 0 to 3 mol %. Bi₂O₃ also has an effect of increasing a refractive index of glass. In addition, since it is possible to slowly change a rate of the variation of viscosity to the variation of a melting temperature, it is easy to form glass. Furthermore, Bi₂O₃ has another effect of extending a vitrification range.

However, when the Bi₂O₃ content is larger than the maximum value, the glass is excessively colored. Therefore, the Bi₂O₃ content is selected in the above-mentioned range so as not to raise a problem in the coloring in the practical aspect.

Moreover, these additional components are contained in the glass body if necessary, or all these components may be contained therein.

Further, the glass body can contain Sb₂O₃ or/and As₂O₃ in a maximum of 1 mol % as a cleaning agent of glass if necessary.

(2) Furthermore, in order to solve the conventional problems, according to the present invention, a K₂O content of the glass body is preferably in a range of 2 to 34 mol %.

Since the glass body contains K₂O larger than 2 mol %, it is easy to make a refractive index distribution of a distributed index lens obtained by ion-exchanging the glass body close to the refractive index distribution represented by Expression 1. Therefore, it is easy to obtain desired lens characteristics.

(3) Moreover, the present invention provides a distributed index lens having a refractive index distribution changed from the center thereof toward the periphery that is obtained by contacting the glass body with the melted salt of a potassium compound to perform ion exchange.

The distributed index lens formed by ion-exchanging the glass body has a refractive index distribution close to the refractive index distribution represented by Expression 1.

Therefore, the rod lens has a wide effective visual field. In addition, since the rod lens is formed by ion exchanging the glass body, the lens has excellent weather resistance.

(4) The present invention provides an optical element in which the distributed index lenses are zero-, one- or two-dimensionally arranged.

In the present invention, the distributed index lenses are zero-, one- or two-dimensionally arranged, which does not cause the periphery of each lens to deviate from the effective visual field of the lens.

Therefore, images obtained from the peripheries of the distributed index lenses arranged in the optical element, serving as noise, do not overlap each other, and thus it is possible to improve an optical characteristic of the entire optical element, such as resolution.

(5) The present invention provides an optical device using the optical element.

Since the optical device uses the optical element having excellent optical characteristics, the optical device also has excellent optical characteristics.

### BRIEF DESCRIPTION OF THE DRAWINGS

FIG. 1 is an explanatory diagram schematically illustrating the distribution of potassium detection intensity by an X-ray microanalysis in a cross section of a distributed index lens according to an embodiment of the present invention.

FIG. 2 is an explanatory diagram schematically illustrating the distribution of potassium detection intensity by the X-ray microanalysis in a cross section of a conventional distributed index lens.

FIG. 3 is a view schematically illustrating the structure of a lens array serving as an optical element according to another embodiment of the present invention.

### REFERENCE NUMERALS

10: LENS ARRAY
11: LENS ELEMENT
12: SUBSTRATE MADE OF FRP
13: BLACK RESIN

### BEST MODE FOR CARRYING OUT THE INVENTION

Hereinafter, preferred embodiments of the present invention will be described with reference to the accompanying drawings.

### First Embodiment

### Example 1

A glass body of the present invention is made of the following raw materials containing metal included in each oxide as the origins of the respective oxides, which are constituents of the glass body shown in Table 1:

Silica powder (silicon oxide), boron oxide, thallium nitrate, potassium nitrate, lithium carbonate, sodium carbonate, rubidium nitrate, cesium nitrate, zinc oxide, germanium oxide, barium nitrate, titanium oxide, magnesium carbonate, zirconium oxide, aluminum oxide, tin oxide, calcium carbonate, strontium carbonate, lanthanum oxide, bismuth oxide, tantalum oxide, antimony oxide, and arsenic trioxide.

A weight ratio of the respective raw materials is determined to have a composition ratio shown in Table 1, and these raw materials are mixed. Then, the mixed raw materials are put in a melting pot made of white gold and are then melted in an electric furnace at 1450° C. Subsequently, the melted glass is stirred well to be uniformed and is then formed into a glass rod having a diameter of 0.6 mmφ.

In order to perform ion exchange, the glass bar is immersed in a melted potassium nitrate that is heated at a temperature shown in Table 1 and is kept at the temperature. In this way, a cylinder-shaped lens of a refractive index distribution type is obtained.

In this case, the weight of the melted nitrate is adjusted such that a weight ratio of the glass bar to the melted nitrate is 2 weight percent.

Table 1 shows a measured aperture angel θ and an effective visual field (percent) of the distributed index lens, which are characteristic values of the lens.

Further, the aperture angle θ described in Table 1 is a maximum incident angel at which the lens can change the direction of luminous flux. In addition, the effective visual field is defined from an image obtained in a case in which an object is located at the incident side and the image obtained from the lens is present at the emission side.

As shown in Table 1, the obtained aperture angle θ of the lens is 15.1°, and the effective visual field is 95%, which shows an excellent characteristic larger than 92%.

Further, the state of the cylinder-shaped lens of a refractive index distribution type can be seen by an X-ray microanalysis method by observing the distribution of the detection intensity of an alkali metal, such as potassium.

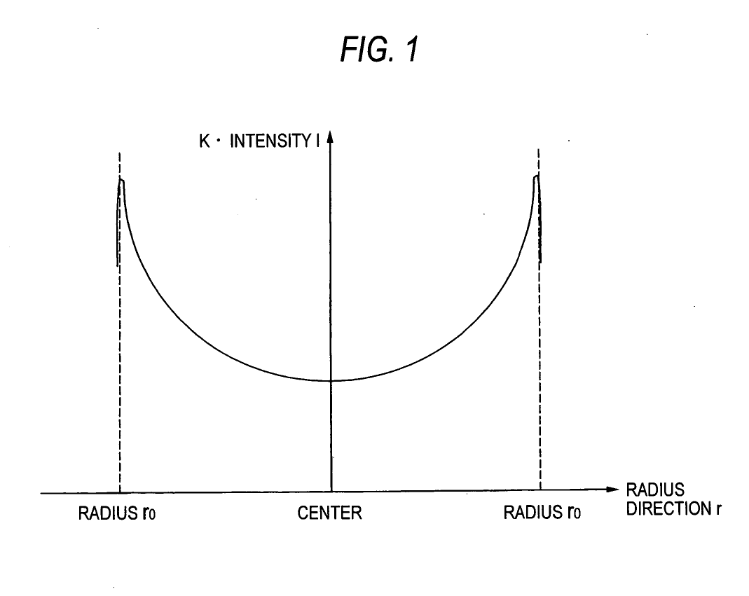

FIG. 1 is an explanatory diagram schematically illustrating the distribution of the detection intensity of potassium obtained by the X-ray microanalysis in the cross section of the obtained distributed index lens.

The distribution of the detection intensity of potassium shown in FIG. 1 has a parabolic distribution substantially in the diametric direction of the cross section of a lens. In particular, in the vicinity of the periphery of the cylindrical lens represented by a dotted line in FIG. 1, the distribution of the detection intensity of potassium is changed along the curved line. This means that the refractive index distribution of the same lens follows a refractive index distribution indicated in Expression 1 well up to the periphery of the cylindrical lens.

### Examples 2 to 16

In examples 2 to 16, the same process as that in the example 1 is performed such that the a glass body has a composition ratio entered in an example column of Table 1, thereby obtaining a distributed index lens. In Table 1, the characteristics of the obtained distributed index lenses are also recorded.

The lenses shown in Table 1 each have an excellent effective visual field lager than 92%. Further, there is no defect in that the glass body is devitrified, or the surface of the lens body has a scratch.

### Comparative Examples 1 to 3

In comparative examples, the same process as that in the example 1 is performed such that the glass body has a composition ratio entered in a comparative example column of Table 1, thereby obtaining a distributed index lens. In Table 1, the characteristics of the obtained distributed index lenses are also recorded.

As shown in Table 1, in the comparative example 1, the obtained lens has an effective visual field of 90%, so that there is a problem in that an image is not formed in the periphery of the lens.

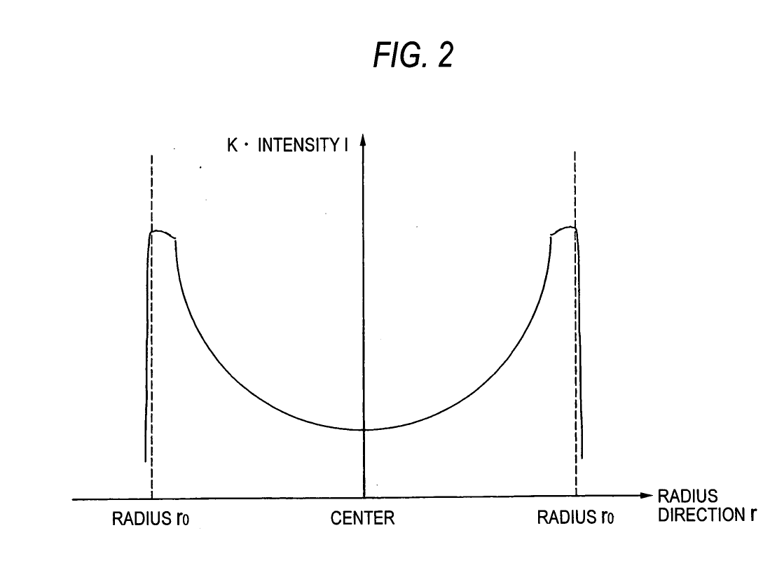

Further, FIG. 2 is an explanatory diagram schematically illustrating the distribution of the detection intensity of potassium obtained by the X-ray microanalysis in the cross section of the same lens.

As can be seen from FIG. 2, a curved line representing the distribution of the detection intensity of potassium deviates from a substantially parabolic curve in the periphery of the cylindrical lens. This means that the refractive index distribution of the same lens deviates from the refractive index distribution represented by Expression 1.

Further, in the comparative example 2, a crack occurs in a circumferential surface of the obtained lens. Therefore, the object of the present invention is not attained. The reason is that, since the glass body does not contain B₂O₃, it has insufficient elasticity, so that the glass body is cracked by a volume variation at the time of ion exchange.

Furthermore, the comparative example 3 has a problem in that, after the ion exchange, a devitrified material occurs in the vicinity of the circumferential surface of the lens. The reason is that, since the glass body does not contain K₂O, a sudden ion exchange of the melted salt with potassium ions generated at the time of an ion exchange process causes a fine crack or devitrification of the glass body.

TABLE 1

| | | Example | | | | | | | | | |
|---|---|---|---|---|---|---|---|---|---|---|---|
| | | 1 | 2 | 3 | 4 | 5 | 6 | 7 | 8 | 9 | 10 |
| Constituent | SiO2 | 57.3 | 58.0 | 59.0 | 58.0 | 57.3 | 59.0 | 56.1 | 49.3 | 62.7 | 46.2 |
| | B2O3 | 2.9 | 0.5 | 3.0 | 1.0 | 2.9 | 2.0 | 1.0 | 11.8 | 3.2 | 14.4 |
| | Ti2O | 7.8 | 5.0 | 5.0 | 5.0 | 4.9 | 5.0 | 5.0 | 4.9 | 3.2 | 3.6 |
| | K2O | 3.9 | 4.0 | 4.0 | 4.0 | 3.9 | 4.0 | 3.2 | 3.9 | 4.3 | 4.1 |
| | Na2O | 11.7 | 12.0 | 12.0 | 12.0 | 14.6 | 12.0 | 12.0 | 13.3 | 8.6 | 14.4 |
| | Li2O | | | | | | | | | | |
| | Cs2O | | | | | | | | | | |
| | ZnO | 11.5 | 15.0 | 12.0 | 12.0 | 11.5 | 12.0 | 20.0 | 11.8 | 12.8 | 12.3 |
| | GeO2 | | | | | | | | | | |
| | BaO | | | | | | | | | | |
| | CaO | | | | | | | | | | |
| | SrO | | | | | | | | | | |
| | TiO2 | 4.9 | 5.5 | 5.0 | 5.0 | 4.9 | 5.0 | 1.2 | 4.9 | 5.2 | 5.0 |
| | MgO | | | | | | | | | | |
| | ZrO2 | | | | | | | | 0.1 | | |
| | Al2O3 | | | | | | | | | | |
| | SnO2 | | | | | | | 1.5 | | | |
| | La2O3 | | | | | | 1.0 | | | | |
| | Ta2O5 | | | | | | | | | | |
| | Bi2O3 | | | | 3.0 | | | | | | |
| | Sb2O3 | | | | | | | | | | |
| | As2O3 | | | | | | | | | | |
| | Total | 100 | 100 | 100 | 100 | 100 | 100 | 100 | 100 | 100 | 100 |
| | Na2O + Li2O | 11.7 | 12.0 | 12.0 | 12.0 | 14.6 | 12.0 | 12.0 | 13.3 | 8.6 | 14.4 |
| | (Na2O + Li2O)/Ti2O | 1.5 | 2.4 | 2.4 | 2.4 | 3.0 | 2.4 | 2.4 | 2.7 | 2.7 | 4.0 |
| | Ti2O + R2O | 23.4 | 21.0 | 21.0 | 21.0 | 23.4 | 21.0 | 20.2 | 22.1 | 16.1 | 22.1 |
| | BaO + CaO + SrO | 0.0 | 0.0 | 0.0 | 0.0 | 0.0 | 0.0 | 0.0 | 0.0 | 0.0 | 0.0 |
| | ZrO2 + Al2O3 + SnO | 0.0 | 0.0 | 0.0 | 0.0 | 0.0 | 0.0 | 1.5 | 0.1 | 0.0 | 0.0 |
| | SiO2 + GeO2 + TiO2 + | 65.1 | 64.0 | 67.0 | 64.0 | 65.1 | 66.0 | 58.3 | 66.1 | 71.1 | 65.6 |
| | B2O3 + ZrO2 + Al2O3 | | | | | | | | | | |
| Ion | Processing | 530 | 550 | 530 | 525 | 530 | 530 | 570 | 530 | 530 | 546 |
| exchange | temperature [° C.] | | | | | | | | | | |
| conditions | Processing time | 39 | 24 | 12 | 24 | 39 | 29 | 34 | 13 | 24 | 16 |
| | [Hour] | | | | | | | | | | |
| Lens | Color | Color- | Color- | Color- | Orange | Color- | Color- | Color- | Color- | Color- | Color- |
| character- | | less | less | less | | less | less | less | less | less | less |
| istics | Aperture angle [°] | 16.7 | 15.1 | 16.4 | 23.1 | 24.0 | 24.3 | 13.5 | 24.5 | 10.8 | 18.8 |
| | Effective visual | 95 | 93 | 99 | 99 | 96 | 98 | 94 | 99 | 99 | 99 |
| | field [%] | | | | | | | | | | |

| | |
|---|---|
| | Comparative |
| Example | example |

| | | 11 | 12 | 13 | 14 | 15 | 16 | 1 | 2 | 3 |
|---|---|---|---|---|---|---|---|---|---|---|
| Constituent | SiO2 | 56.1 | 57.1 | 53.0 | 48.0 | 47.0 | 60.8 | 59.0 | 57.3 | 60.0 |
| | B2O3 | 2.5 | 1.5 | 6.0 | 1.0 | 7.7 | 5.5 | | | 14.0 |
| | Ti2O | 4.9 | 4.9 | 5.0 | 5.0 | 8.5 | 4.6 | 7.0 | 4.9 | 4.0 |
| | K2O | 3.9 | 3.9 | 4.0 | 4.0 | 3.8 | 3.7 | 2.5 | 3.9 | |
| | Na2O | 13.3 | 13.3 | 11.0 | 11.0 | 10.6 | 12.4 | 14.0 | 14.6 | 19.0 |
| | Li2O | | | 1.0 | | 0.5 | | | | |
| | Cs2O | | | | | 2.9 | | | | |
| | ZnO | 11.4 | 11.4 | 12.0 | 8.0 | 6.5 | 5.5 | 9.1 | 13.2 | 3.0 |
| | GeO2 | | | | 11.0 | 1.9 | | | | |
| | BaO | | 3.0 | | | | | | | |
| | CaO | | | | | | 6.3 | | | |
| | SrO | | | | | | | | | |
| | TiO2 | 4.9 | 4.9 | 5.0 | 5.0 | 2.5 | 0.9 | 8.0 | 4.9 | |
| | MgO | | | | 4.0 | 3.8 | | | | |
| | ZrO2 | | | | | 0.7 | 0.1 | | 1.0 | |
| | Al2O3 | 3.0 | | | | | | | | |
| | SnO2 | | | 3.0 | 3.0 | 2.9 | | | | |
| | La2O3 | | | | | 0.5 | | | | |
| | Ta2O5 | | | | | | | | | |
| | Bi2O3 | | | | | | | | | |
| | Sb2O3 | | | | | 0.2 | 0.2 | 0.4 | 0.2 | |
| | As2O3 | | | | | | | | | |
| | Total | 100 | 100 | 100 | 100 | 100 | 100 | 100 | 100 | 100 |
| | Na2O + Li2O | 13.3 | 13.3 | 12.0 | 11.0 | 11.1 | 12.4 | 14.0 | 14.6 | 19.0 |
| | (Na2O + Li2O)/Ti2O | 2.7 | 2.7 | 2.4 | 2.2 | 1.3 | 2.7 | 2.0 | 3.0 | 4.8 |
| | Ti2O + R2O | 22.1 | 22.1 | 21.0 | 20.0 | 26.3 | 20.7 | 23.5 | 23.4 | 23.0 |
| | BaO + CaO + SrO | 0.0 | 3.0 | 0.0 | 0.0 | 0.0 | 6.3 | 0.0 | 0.0 | 0.0 |
| | ZrO2 + Al2O3 + SnO | 3.0 | 0.0 | 3.0 | 3.0 | 3.6 | 0.1 | 0.0 | 1.0 | 0.0 |
| | SiO2 + GeO2 + TiO2 + | 66.5 | 63.5 | 64.0 | 65.0 | 59.8 | 67.3 | 67.0 | 63.2 | 74.0 |
| | B2O3 + ZrO2 + Al2O3 | | | | | | | | | |
| Ion | Processing | 550 | 550 | 500 | 530 | 550 | 530 | 530 | 530 | 530 |
| exchange | temperature [° C.] | | | | | | | | | |
| conditions | Processing time | 36 | 28 | 24 | 35 | 45 | 48 | 46 | 39 | 50 |
| | [Hour] | | | | | | | | | |
| Lens | Color | Color- | Color- | Color- | Color- | Color- | Color- | Color- | Crack | White |
| character- | | less | less | less | less | less | less | less | | |
| istics | Aperture angle [°] | 15.7 | 17.6 | 25.4 | 21.4 | 23.1 | 13.1 | 22.8 | — | — |
| | Effective visual | 94 | 93 | 94 | 96 | 97 | 93 | 90 | — | — |
| | field [%] | | | | | | | | | |

### Second Embodiment

### Example

Concave and convex portions are formed on a cylindrical surface of the cylindrical lens of a refractive index distribution type formed in the example 1 of the first embodiment, and a black resin is then coated on the surface, thereby obtaining a lens element.

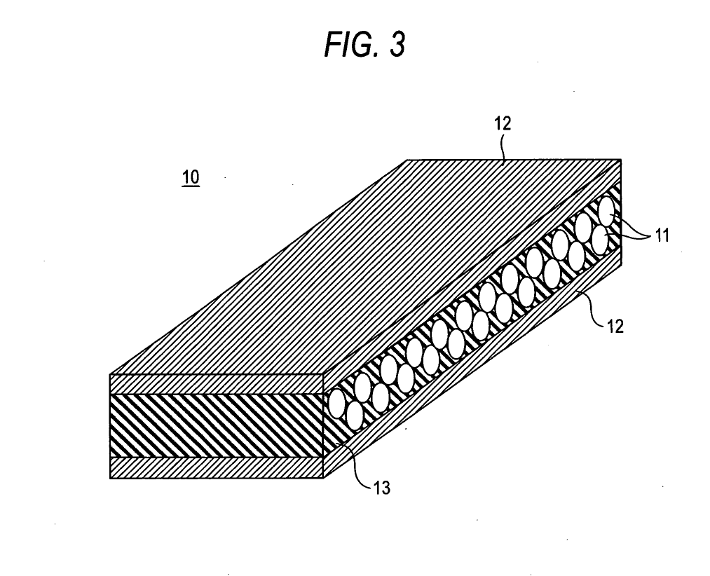

FIG. 3 is a perspective view schematically illustrating the structure of a lens array in which the lens elements are two-dimensionally arranged.

As can be seen from FIG. 3, a lens array 10 is constructed by arranging a plurality of lens elements 11 two-dimensionally and by interposing the plurality of lens elements 11 between a pair of substrates 12 made of a fiber reinforced plastic (FRP). In addition, a black resin 13 is filled in gaps between the substrates 12 made of FRP and the plurality of lens elements 11.

The reproducibility of an image is estimated by the optical characteristics of the lens array formed in this way. The estimation is achieved by measuring a reproduction ratio of an image using a modulation transfer function (MTF) method. That is, a predetermined line chart is located at the incident side of the lens array, and an image obtained by illuminating light from a halogen light source to the line chart through a color filter and a light diffuser sheet passes through the lens array to be formed as a one-to-one real image at the output side. At that time, a reproduction ratio of the real image with respect to the incident light is measured.

The present embodiment uses a line pattern in which a group of square-wave line pairs indicates on/off and eight groups of line pairs are arranged within a gap of 1 mm (8 lpm: lines per millimeter).

In the lens array of the present embodiment, the reproduction ratio of an image is 84%, which is an excellent value since it is larger than 80%.

It is possible to constitute an optical device having excellent optical characteristics by using the lens array having the above-mentioned structure. That is, a scanner or duplicating machine having the lens array of the present embodiment as an image reading device reproduces a high-resolution and high-definition image.

Further, it is possible to reproduce a high-resolution and high-definition image with a printer constructed by incorporating the lens array having the above-mentioned structure and a light-emitting element into an image forming device.

### Comparative Example

According to a comparative example, a lens array having a lens element manufactured by the conventional technique is constructed by the same method as in the above-mentioned example, and optical characteristics of the lens array are estimated. The lens array according to the comparative example has an image reproduction ratio of 79.6%, which is less than 80%. This is because the refractive index distribution of the lens element manufactured by the conventional technique deviates from the preferred refractive index distribution. That is, since the periphery of each of a plurality of cylindrical lens elements deviates from the effective visual field, images obtained from the peripheries of the respective lens elements overlap each other as noise, which results in the deterioration of optical characteristics of the entire lens array.

[Modifications]

In the second embodiment, a lens array having a plurality of lens elements two-dimensionally arranged is used as an optical element, but the present invention is not limited thereto. That is, it is possible to use a zero-dimensionally arranged lens element as an optical element. In other words, it is possible to use a lens as the optical element. Further, it is also possible to use a lens array in which optical elements are one-dimensionally arranged.

This application relates to and claims priority from Japanese Patent Application No. 2003-085226, filed on Mar. 26, 2003, the entire disclosure of which is incorporated herein by reference.

### INDUSTRIAL APPLICABILITY

As described above, according to the present invention, it is possible to provide a lens body suitable for manufacturing a distributed index lens having a wide effective visual field and excellent weather resistance. In addition, it is possible to provide an optical element having excellent optical characteristics and an optical device with the same by using the distributed index lens of the present invention.

1. A glass body containing thallium, consisting of:
35 to 80 mol % of SiO₂, 0.1 to 40 mol % of B₂O₃, 1 to 26 mol % of Tl₂O, 1 to 34 mol % of K₂O, 0 to 30 mol % of ZnO, 0 to 30 mol % of GeO₂, 0 to 20 mol % of TiO₂, 0 to 20 mol % of MgO, 0 to 2 mol % of ZrO₂, 0 to 8 mol % of Al₂O₃, 0 to 5 mol % of SnO, 0 to 5 mol % of La₂O₃, 0 to 8 mol % of Bi₂O₃, 0 to 2 mol % of Ta₂O₅, 0 to 1 mol % of Sb₂O₃, and 0 to 1 mol % of As₂O₃,
wherein the glass body contains 2 to 26 mol % of Na₂O+Li₂O,
0.2 to 5.5 mol % of (Na₂O+Li₂O)/Tl₂O,
5 to 35 mol % of Tl₂O+R₂O (where R is an alkali metal),
0 to 10 mol % of BaO+CaO+SrO,
0 to 8 mol % of ZrO₂+Al₂O₃+SnO(SnO₂), and
50 to 80 mol % of SiO₂+GeO₂+TiO₂+B₂O₃+ZrO₂+Al₂O₃.

2. The glass body according to claim 1,
wherein the glass body contains 2 to 34 mol % of K₂O.

3. A distributed index lens having a refractive index distribution varied from a center thereof toward a periphery, formed by contacting the glass body according to claim 1 with a melted salt of a potassium compound to perform the ion exchange.

4. An optical element in which the distributed index lenses according to claim 3 are zero-, one- or two-dimensionally arranged.

5. An optical device having the optical element according to claim 4.
